(19) United States
(12) Patent Application Publication
(10) Pub. No.: US 2014/0297711 A1
(43) Pub. Date: Oct. 2, 2014

(54) METHOD AND FRAMEWORK FOR CONTENT VIEWER INTEGRATIONS

(71) Applicant: 3S INTERNATIONAL, LLC., NORTH POTOMAC, MD (US)

(72) Inventor: Xiaopeng He, North Potomac, MD (US)

(21) Appl. No.: 13/952,102

(22) Filed: Jul. 26, 2013

Related U.S. Application Data
(60) Provisional application No. 61/806,801, filed on Mar. 29, 2013.

(51) Int. Cl. H04L 29/08

(52) U.S. Cl. CPC H04L 67/10; H04L 67/02
USPC 709/202

(57) ABSTRACT

A method and an architectural framework are revealed for content viewer integrations in content management systems and platforms that allow plug-and-play style content viewer deployment and switching, and simultaneous display of different viewers on the same page. By introducing the notion of viewer integration profiles and viewer bundles, and providing a programmable framework for integrations and customizations, viewer integrations and deployment in a content management system are standardized and made easy. With the integration of annotation content conversions, switching of content viewers with less data loss and less risk of potential security breaches (caused by incompatibility between different content viewers) will be enabled.

### CROSS REFERENCE TO RELATED APPLICATIONS

This application claims the priority to currently pending U.S. Provisional Patent Application Ser. No. 61/806,801 filed on Mar. 29, 2013 titled “METHOD AND FRAMEWORK FOR CONTENT VIEWER INTEGRATIONS”.

### FIELD OF THE INVENTION

This invention is related to the field of computer software technology. More specifically, the invention relates to methods and apparatus for content viewer integrations in content management systems and platforms.

### BACKGROUND OF THE INVENTION

Content viewers are widely used in various content management platforms and systems. Content viewers help users to visualize the contents of various types of digital documents and images that are stored in the repository of a content management system, as well as on user's desktop machines and network shared drives. Content viewers are also frequently used in organizations as collaboration tools among users via the utilization of annotation/markups and redactions. Some content viewers are even used for manipulating the contents of documents, such as appending, deleting, extracting or reordering the pages. Content viewing is an essential part of any content management systems.

There are many content viewers and content viewer vendors in the market today. Some content viewers are designed to handle documents of specific formats, such as Adobe Acrobat and Adobe Reader for creating, manipulating and displaying PDF file format. Microsoft Office is designed specifically for creating, manipulating and displaying Microsoft Office file formats (Word, Excel, PowerPoint etc.). However, some content viewers are designed to display documents and images of many different formats in the read-only fashion. Some content viewers are standalone applications. When instantiated and opened, they display documents and images in a standalone window, normally with menu bars and toolbars at the top. Adobe Reader and Microsoft Office are examples of standalone viewers. While other content viewers are browser plug-ins built on top of various plug-in technologies such as Java Applet and ActiveX control etc. With the content viewing seamlessly integrated with the rest of the content management systems, content viewers that can be embedded in browser pages become more popular since they allow the end users to view the document content at the same time as viewing the metadata of the document, extra information such as customer ID, owner of the document, the creation date, the category and grouping of the document etc. which are normally not part of the document content being displayed in the viewer. The metadata can be displayed side by side with the content viewer. This saves end users time on switching back and forth between the content viewer window and the window that displays the metadata. Plug-in based content viewers certainly have some advantages, and disadvantages. For example, plug-in based content viewers normally require download from the server and considerable footprint at the client side. With the advancement of HTML technologies and standards, some content viewers are designed without using any browser plug-in technologies but still maintaining a rich user interface and a competitive content viewing feature set. The vendors of this new breed of content viewers emphasize the zero-footprint nature of the viewer runtime. These light weight content viewers actually rely on the back end servers to render the high resolution images for read-only display of the documents at the client side. There are huge anticipations on what HTML 5 can provide in terms of imaging and content viewing.

As content viewers become more and more an integral part of content management systems and platform offerings, which are quickly moving towards the web and cloud for easy deployment, maintenance and management, content viewing technologies and products that support embedding the content viewer in browsers are becoming mainstream and dominant. All major providers of content management platforms have content viewing offerings that include the support of usage from major browsers. Some providers rely on home-grown content viewers. Others offer integrations with the content viewer products from 3^{rd} party vendors. Due to the complexity of imaging technologies and standards, even if a home-grown content viewer is adopted and integrated in a content management platform or system, the production and maintenance of the viewer is more likely from a different division of the company that provides the content management platform or system. A development process of integrating a content viewer into the content management platform or system is usually required. This is especially true when a viewer is required to be embedded and placed on a HTML page, with the precise location, size and style treated as transparently as the other HTML elements. The requirement of integration is obvious for the case of 3^{rd} party content viewers which may use different content viewing technologies, have different programming interfaces and different user experiences, normally are separately licensed and supported from the rest of the components of the entire content management platform or system. In this invention, we only discuss the integrations of content viewers that can be embedded in HTML pages. Standalone content viewers such as Microsoft Office and Adobe Reader are out of scope of this invention.

The difference between a content management system and a content management platform is that a content management system is designed for a specific business where the back-end data structure is normally hardwired with the front-end user interface, and the business logic implemented at the middle layer is more or less tailored for the specific business or industry. In contrast, a content management platform is more abstract at the back-end data layer and the middle tier, capable of generating different front-end applications for a variety of different businesses and industries. A content management platform normally comes with a designer tool or application generator that can create different applications given a set of business requirements for content management. From the content viewer integrations perspective, one of the designer's tasks is to place a content viewer at a specific location with a specific size on an HTML page which may or may not involve other HTML elements for the display of the metadata of the same document. A content management platform is generally more sophisticated than a competing content management system. The industry sometimes uses ECM (Enterprise Content Management) to refer to content management offerings with support at the platform level. Since conceptually a content management system can be seen as a subset of a more general-purpose and abstract content management platform, to simplify the terminology, we refer to content management systems and content management platforms both as ECM systems, without differentiating them any further.

There are many ways of integrating a content viewer into an ECM system. For simple differentiations, they can be categorized into two different approaches: direct integrations and indirect integrations. The direct integration approach hardwires a specific content viewer with the rest of the components of a web application. Hardwiring may happen in many ways including but not limited to viewer identification, viewer rendering, viewer instantiation and initialization, viewer automations, viewer deployment, event handling, service invocations and server communications, and even data in the repository. Several different ways of hardwiring are described in detail in the following sections. A typical characteristic of the direct integration approach is that switching of one content viewer to another normally requires code changes at the ECM system. This characteristic of direct viewer integration means that the ECM system providers effectively lock their customers into a specific content viewer with structural features that are not conducive to switching between viewers. If a customer of such an ECM system wants to switch to another content viewer, the integration know-how must be obtained and a non-trivial development cost must be incurred in order to achieve the goal.

On the other hand, an indirect integration approach abstracts many of the integration points to a dedicated space within the ECM system. It doesn't hardwire any content viewer with the rest of the components of the ECM system. An indirect integration approach treats a content viewer as one of the replaceable components that can be customized, replaced, switched, and instantiated and shown side-by-side on the same HTML page with other HTML components including another viewer from another viewer provider. It leaves the decision on which content viewer to choose to the end user or customer, by making the switching of content viewers easy, possibly in the fashion of plug-and-play, without the high development cost for customization of the ECM system and the cost of acquiring the integration know-how. This invention discloses a method and an architectural framework for indirect content viewer integrations with the support of plug-and-play-style viewer switching in ECM systems.

Modern content viewers are capable of much more than simply displaying documents to end users. They provide more sophisticated functionalities and user interfaces than any other HTML elements. Basic functionalities that come with a content viewer include page navigations, zoom in/out, rotation, printing, annotations/redactions, and inline searching of text within a document, as well as other even more advanced features. Given the existence of a large number of file formats and imaging standards and different content viewing requirements from different customers, there is no single content viewer in the market today that can meet all the business requirements of all customers. Some content viewers are good at displaying a certain set of file formats. Some content viewers offer a set of features and technologies that are tailored to meet a particular customer's specific requirements in areas such as total cost of ownership (TCO), security, performance and productivity in addition to document display requirements. Some content viewers have fewer bugs and the viewer vendors are very effective at addressing any technical issues. Some content viewers have intuitive and friendly user interfaces. Some content viewers work with more web browsers. Some content viewers have adopted more advanced technologies than others. Some content viewers are simply outdated, and the viewer vendors are no longer actively supporting the viewer products. Obviously customers of ECM systems have a variety of options to choose from in order to meet their specific business requirements on content viewing needs. Finally, when a customer of an ECM system switches and migrates to another ECM system, the customer may have to switch the content viewer if the content viewer they have licensed is not what the new ECM system natively supports. It is the responsibility of ECM system providers to prepare the ECM system to satisfy customers' need to switch between content viewers, and possibly to use multiple content viewers simultaneously during ECM system runtime. Ideally, the switching of content viewers should not result in any data loss or security breach consequences for the customers. A viewer framework and an architectural design of an ECM system that gives customers freedom of choice, and easy switching and replacement of content viewers in the fashion of plug-and-play will certainly help to meet customers' ultimate demand for flexibility, convenience and lower overall long-term cost in the ever-changing business world. In this regard, a viewer framework that integrates annotation conversion tools described in patent application Ser. No. 13/591,396 which is incorporated by reference would allow customers to switch content viewers without annotation data loss and potential security issues.

### SUMMARY OF THE INVENTION

It is an object of this invention to provide ECM systems that allow the deployment and switching of content viewers with the plug-and-play style by simply dropping a new viewer bundle into a predefined location and removing the old viewer bundle from the same location.

It is yet another object of this invention to provide ECM systems that allow simultaneous and side-by-side usage of multiple content viewers on the same client at runtime.

It is yet another object of this invention to provide ECM systems that prevent annotation data loss during or after switching of content viewers that are incompatible with each other in annotation data formats, and keeps data transparency between content viewers and other components of the system that may consume the annotation data generated by content viewers.

It is yet another object of this invention to provide a viewer integration framework (VIF) that simplifies the process of viewer integrations yet allows customizations of the default behaviors.

It is yet another object of this invention to provide a method to identify a viewer provider in ECM systems both at design time and runtime by the use of viewer integration profiles (VIP).

It is yet another object of this invention to provide a method to package all content viewer related artifacts into a viewer bundle for easy distribution, deployment, and handling both at runtime and design time.

### BRIEF DESCRIPTION OF THE DRAWINGS

FIG. 1 illustrates an exemplary ECM system with a built-in viewer integration framework (VIF).

FIG. 2A illustrates the high level structure of an exemplary viewer integration profile (VIP) for identifying a viewer provider in an ECM system.

FIG. 2B illustrates the content for the <system> category of an exemplary VIP. Data contained in this category describe the features and functionalities that an ECM system requires, but which may or may not be available from a particular viewer.

FIG. 2C illustrates the content of the <enablement> category of an exemplary VIP. Data contained in this category enable/disable the features that this particular viewer supports.

FIG. 2D illustrates the content of the <formats> category of an exemplary VIP. Data contained in this category declare all file formats that this particular viewer control supports the display of.

FIG. 2E illustrates the content of the <environment> category of an exemplary VIP. Data contained in this category set up the environment that this viewer control is going to be running in and the services this viewer control will invoke at runtime.

FIG. 2F illustrates the content of the <control> category of an exemplary VIP. Viewer attributes and parameters are listed here for the automatic rendering of the viewer control at runtime.

FIG. 3A illustrates the internal structure of an exemplary viewer bundle.

FIG. 3B illustrates the content of a customized manifest for viewer bundles.

FIG. 4 illustrates an automatic process for the VIF to dynamically select the viewer provider for viewer instantiation at runtime.

FIG. 5A illustrates the content of an exemplary viewer format mapping. Given the name of the format of a document, the VIF can look for a suitable viewer provider at runtime to handle the document.

FIG. 5B illustrates the process of the VIF dynamically selecting the viewer provider at runtime from the viewer format mapping.

FIG. 6A illustrates two viewer widgets displayed side-by-side on the same client.

FIG. 6B illustrates a single viewer widget displayed on the client, with the viewer widget having a viewer object and a thumbnail control displayed side-by-side within.

FIG. 6C illustrates a single viewer widget displayed on the client, with the viewer widget having two viewer objects displayed side-by-side within for comparison of two documents.

### DETAILED DESCRIPTION OF THE INVENTION

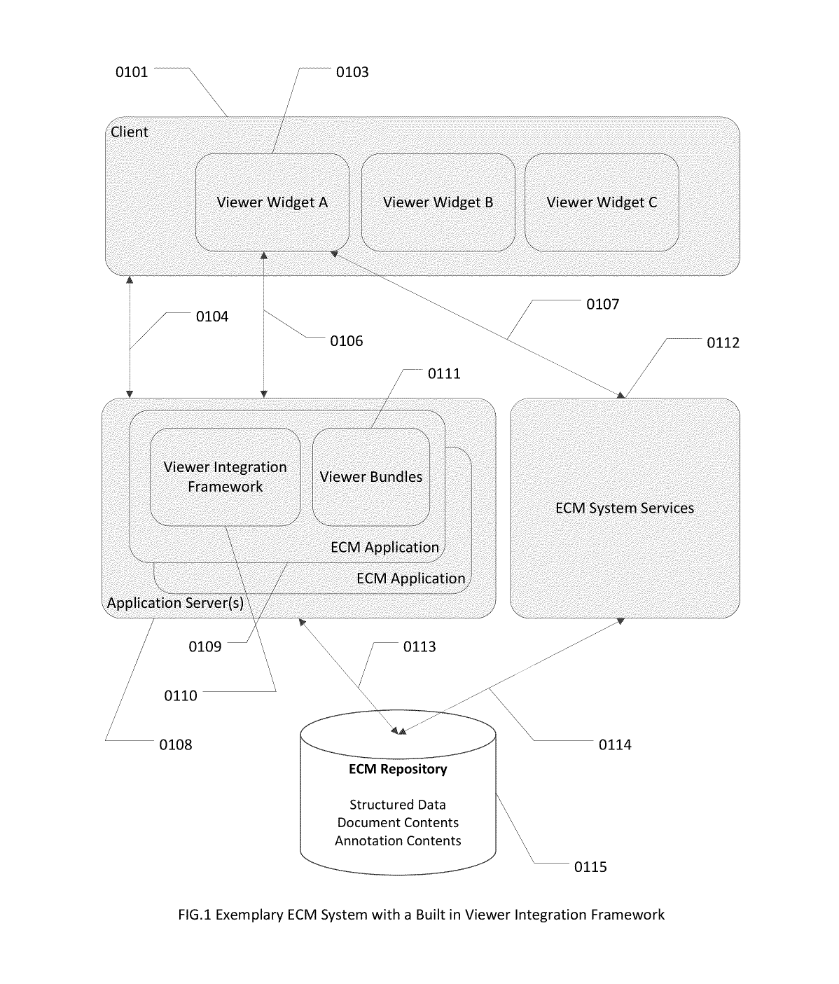

FIG. 1 illustrates an exemplary ECM system that supports multiple content viewers and a viewer integration framework (VIF) for managing them. Divided into client side and server side, the exemplary ECM system includes at the client side one or more clients 0101 with Viewer Widget A 0103, Viewer Widget B, Viewer Widget C, and possibly other widgets or controls running side-by-side on the client application. Viewer Widget A 0103, Viewer Widget B and Viewer Widget C are all instances of viewer widgets that each encapsulates viewer controls. Such viewer controls may be from the same viewer provider, or they may be from different providers. The same viewer vendor may have different integrations for different content viewer offerings due to the differences between the offerings. The extreme scenario is that two different versions of the same viewer control from a viewer vendor having significant changes in the interfaces, data format and other integration points that different viewer provider must be created to cover the differences in how they interact with the VIF. Viewer Widget A 0103 is a client-side integration framework that knows how to instantiate various viewer controls from different viewer providers at runtime. The client-side integration framework includes facilities such as viewer selection, viewer control rendering, event handling, viewer control automation, and a server-side invoking service etc. Client 0101, Viewer Widget A 0103 and the viewer control encapsulated inside all have connections to the server and may request data from or post data to the server. The exemplary ECM system also includes at the server side one or more application servers 0108 which host one or more ECM Applications 0109. ECM Application 0109 includes Viewer Integration Framework (VIF) 0110 and Viewer Bundles Facility 0111, as well as other server side components. The server side also includes ECM System Services 0112 that provides services to the ECM Application 0109 and the Viewer Integration Framework (VIF) 0110, as well as the client side directly. ECM Application 0109 and ECM System Services 0112 are both connected to ECM repository 0115 where structured data and unstructured data such as document contents and annotation contents are stored. The Viewer Bundles Facility 0111 is a single location that hosts all viewer bundles deployed for each ECM Applications. This is one exemplary method of designating a location for viewer bundle deployment. Alternative method is to designate a single location for viewer bundle deployment for all ECM applications. This way, switching viewers from this location will cause all ECM applications switching viewers. Viewer Integration Framework (VIF) 0110 manages and delivers resources from each viewer bundle upon requests from the client side. Viewer Integration Framework (VIF) 0110 comprises facilities and interfaces for server side integrations of viewer providers such as selecting viewer providers, rendering viewer controls, handling requests from the client side, and delegating client requests to the server for implementations of a viewer and communicating with the rest of the ECM Application 0109 and ECM Repository 0115. Depending on actual implementations, viewer provider selection and viewer control rendering can be done either at the client side or at the server side.

At runtime, when a user picks a document for display, Client 0101 instantiates and then invokes Viewer Widget A 0103 with an identifier that identifies the document to display. The document identifier might be as simple as a string that uniquely identifies a document in ECM repository 0115, or might be a combination of document ID string and the content type of the document, or might be a complete file path of a document on the local hard drive, or might be a URL for a file on the network. Providing the content type of the document saves time for looking up the content type from a given document ID string. A content type string is required for the VIF to select a viewer provider from among multiple viewer providers in the system to display the document and the associated annotations. Once a viewer provider is chosen to display the document that a user has picked, Viewer Widget A 0103 is responsible for instantiating the viewer control at the client side and placing the viewer control in the designated location and with the designated size and style on Client 0101. Before the instantiations, if the executable code for Viewer Widget A 0103 is not already on the client side, Client 0101 may request the executable code to be downloaded from the server via connection 0104. Likewise, before the instantiations, if the executable code for the viewer control encapsulated in Viewer Widget A 0103 and the associated client side integration implementations are not already on the client side, Viewer Widget A 0103 will request the download of the corresponding artifacts from the server side via connection 0106. For proper instantiation and initialization of the viewer control, Viewer Widget A 0103 may request extra data from the server side via connection 0106. Extra data may include, but is not limited to, information such as design time context and runtime context that are essential for the rendering of viewer controls. Runtime context and design time context will be covered in later sections. The viewer initialization process may be delegated to the implementation of each viewer. After the viewer control is instantiated and initialized successfully, Viewer Widget A 0103 then requests data from the server side for the display of the document and any annotation contents that are associated with the document. This is done via connection 0106, and if ECM System Services 0112 has services for delivering document and annotation contents, also through connection 0107. Viewer Widget A 0103 is also responsible for handling any events that a viewer control may raise during and after the initialization process. Such event may trigger reactions from Viewer Widget A 0103, or may affect the display status of other components displayed side-by-side on Client 0101. A good example is a thumbnail control that displays the individual pages of a document in thumbnail sizes. The event that a viewer control fires to indicate successful loading of the document may trigger the thumbnail control to query the viewer control for the total number of pages of the document in order for the proper initialization of the thumbnail control.

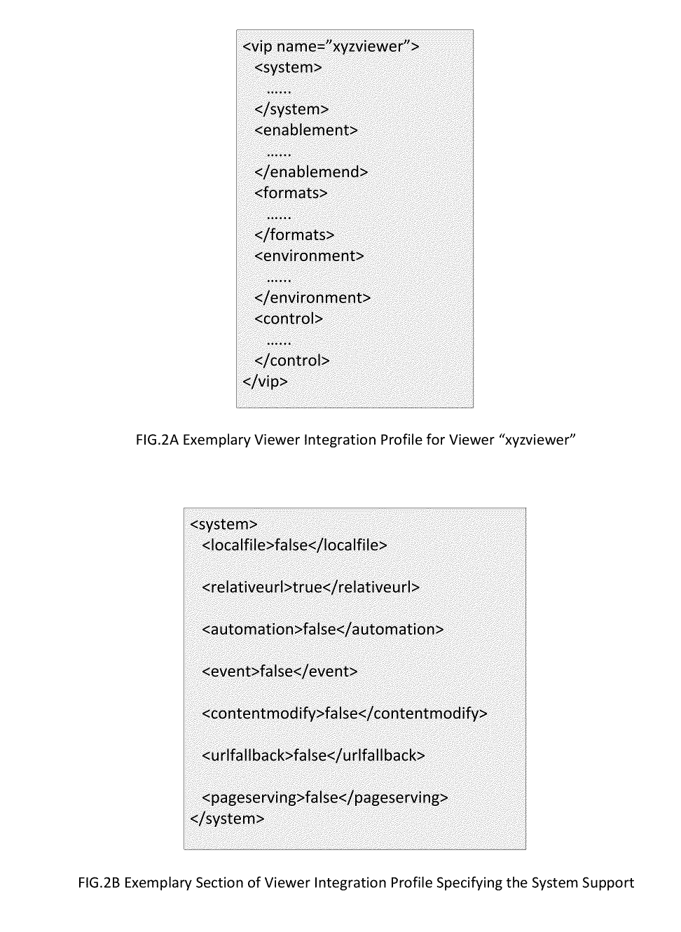

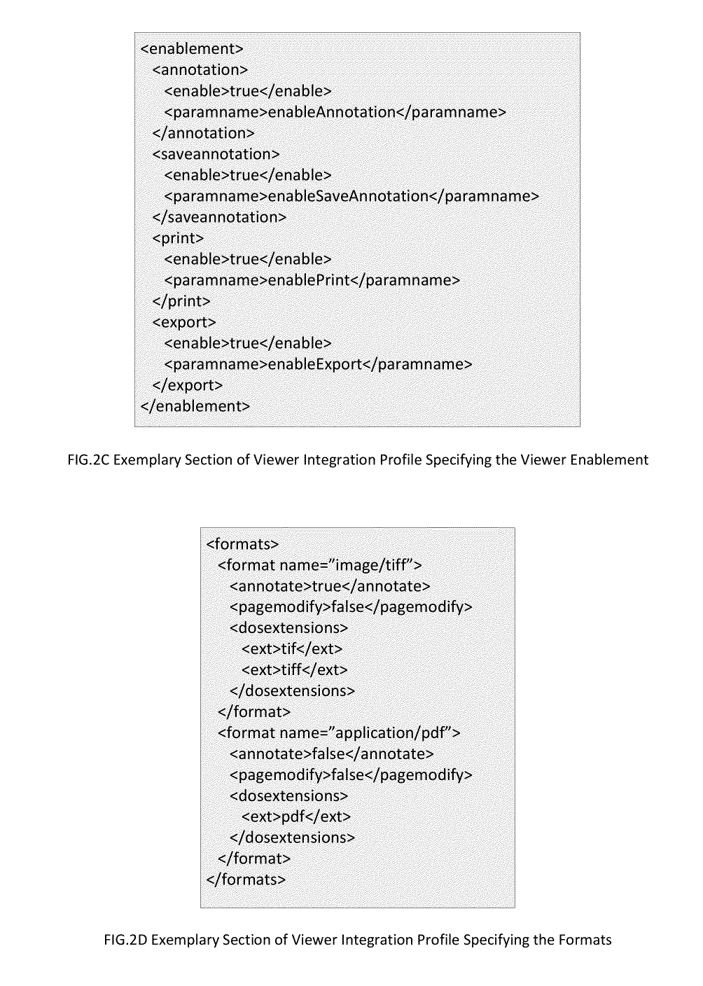

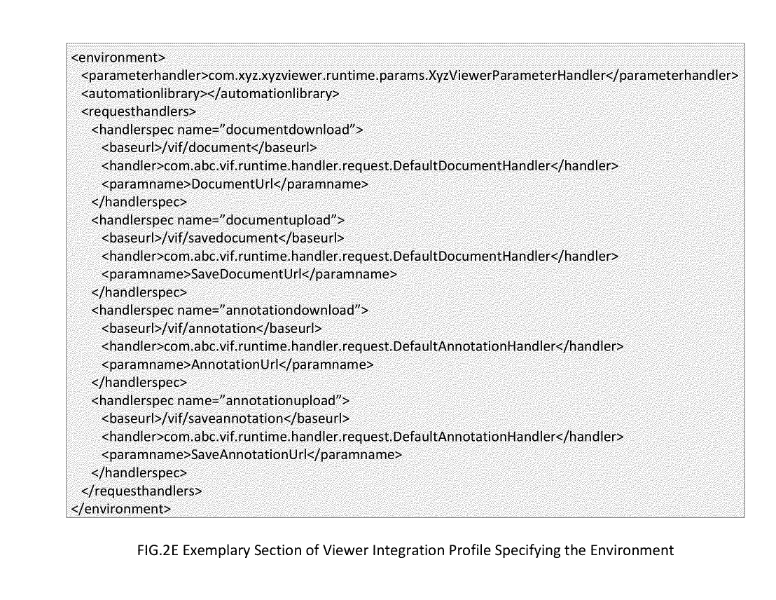

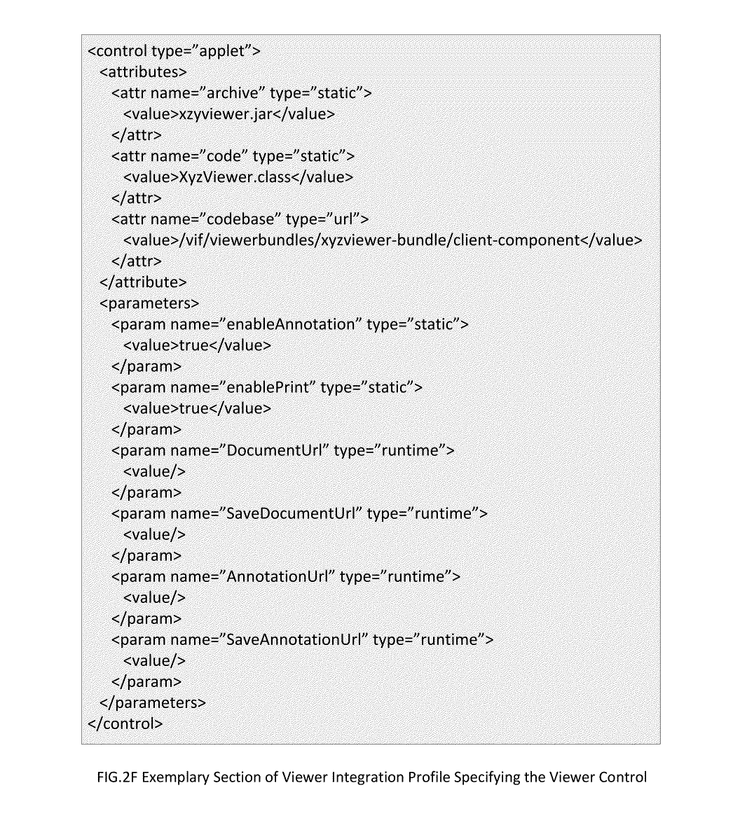

FIG. 2A illustrates the high-level structure of an exemplary viewer integration profile for identifying a viewer provider in an ECM system. With multiple content viewers deployed in an ECM system, there must be an identification mechanism for identifying each viewer provider. A unique name for each individual viewer provider is a good start, but not enough. Different content viewers have different capabilities and are built on different technologies. For example, some content viewers support certain file formats that others don't. Some content viewers come with a thumbnail control that displays individual pages in small scale and resolutions, while others don't. Some content viewers support automation and events while others don't. Some content viewers have image toolbars and annotation toolbars while others don't. Different content viewers have different sets of initialization parameters. Different content viewers might be built on top of different technologies. The list goes on and on. Further, there is lack of standardization on the interactions between a content viewer and the hosting client, and between the content viewer and the server. Even if two content viewers are built on the same technology, they might interact differently with the hosting client and communicate differently with the server. Different content viewers from different venders likely use different data formats for annotations and redactions. Some viewer vendors may have significant changes for different versions of the same viewer. The concept of viewer provider captures such differences from the perspective of integrations. It would be ideal to use a unique name to serve as a key to a set of data that collectively identifies a viewer provider. The viewer integration profile (VIP) serves the purpose of identifying a viewer provider in an ECM system. A viewer provider refers to a unique content viewer in an ECM system, identified by a viewer provider name which is unique among all viewer providers in the ECM system. An ECM system should not allow duplication of viewer provider names. Whenever a viewer provider is mentioned, it refers to the content viewer itself plus its integrations in an ECM system. A VIP is a set of data grouped and organized into a well-known data format (such as XML) that collectively identify a specific viewer provider as it is integrated into an ECM system. It not only describes the viewer control, but also describes the environment in which the viewer control is going to run. The VIF uses various settings in the VIP to render the viewer control at runtime. A design tool can also use data stored in the VIF for design-time operations such as enumerating all viewer providers and finding the viewer provider that supports a specific file format. Depending on actual implementations of the Viewer Widget 0103, the viewer provider name might be sufficient for manipulating viewers at design time. However, the entire VIP is required at runtime for rendering viewer controls.

FIG. 2A shows an exemplary VIP for a viewer provider named “xyzviewer”. This exemplary VIP is in XML data format comprising 5 categories of data: <system>, <enablement>, <formats>, <environment> and <control>. Provider name is specified in the “name” attribute of the root element.

The <system> element includes settings for a list of system-level content viewing features that an ECM system requires. As shown in FIG. 2B, it lists a set of features that a viewer provider may or may not support but may affect how the VIF works at runtime. For example, the <localfile> setting declares that the viewer provider does not support the display of a local file. When this viewer provider is asked to display a local file at runtime, by looking at this setting the VIF can provide special treatment to viewer providers that do not handle the local file. Such special treatment is needed for all zero footprint content viewers in order to display local files. A very simple special treatment is to display a warning message informing the user that the viewer provider simply can't display local files. Alternatively, the VIF can upload the local file to a temporary location on the server side, transform the uploaded file to the format that the light-weight viewer can display and then ask the viewer to display the transformed document from a URL. Another example is the <relativeurl> setting which declares that the viewer provider does support retrieving data from or posting data to the server side using a relative URL. All service URLs for this viewer will be generated as relative URLs. If this value is set to false, the VIF will generate absolute URLs so that the viewer control can still receive data from or post data to the server side.

FIG. 2C shows the content of the <enablement> element of an exemplary VIP. Settings in this category enable/disable the features from this particular viewer. For example, the <annotation> element is for enabling or disabling the annotation feature from the viewer control. The <enable> sub-element under the <annotation> element is set to true in this case which means annotations will be retrieved and displayed at runtime if there are any annotations associated with the document. The <paramname> sub-element specifies the name of the initialization parameter of the viewer control by which the annotation feature can be enabled or disabled. By looking up the <enable> and <paramname> elements in this category, the VIF is able to automate the rendering process for the viewer initialization parameters, in this case “enableAnnotation” as shown in FIG. 2F.

FIG. 2D shows the content of the <formats> element of an exemplary VIP. This element contains a list of file formats that this particular viewer provider is able to display. In this example, the viewer provider supports two file formats, TIFF and PDF. In addition to the name of the file format, in this case the MIME type string, extra information is provided to help the VIF deal with this viewer control. The <annotate> element under the <format> element informs the VIF whether users can annotate documents of this particular file format from this viewer control. If not, the annotation toolbar must be greyed out or completely disabled. The <pagemodify> element informs the VIF whether users can perform page modification operations on documents of this particular file format. If not, user interface elements for page modification operations must be disabled. Finally, the <dosextension> element contains a list of DOS extensions that the file format may have. This piece of information helps the framework detect the file format from a local file without looking into the content of the local file.

FIG. 2E shows the content of the <environment> element of an exemplary VIP. Settings in this category describe the environment that this viewer control will be running in. This section specifies the services this viewer control requires at runtime and also specifies server-side implementations that handle various service requests from the client side. In this exemplary VIP, there are three sub-elements under the <environment> element: the <parameterhandler> element that specifies the implementation class for handling custom attributes and parameters; the <automationlibrary> element that specifies the client side JavaScript library that implements the interfaces defined by the client side viewer integration framework; and the <requesthandlers> element that specifies the implementation classes for handling various requests from this viewer control at runtime. In this particular example, the com.xyz.xzyviewer.runtime.params.XyzViewerParameterHandler class is specified for the <parameterhandler> element. This suggests that this viewer provider has some custom initialization parameters that the framework can't handle, rather requires the viewer integration for this viewer provider handle such parameters by itself. If the viewer control doesn't have any custom initialization parameters, this element can be empty because the class specified here will not be invoked if there is no custom attribute/parameter specified in the viewer integration profile. Details of viewer attributes and parameters specifications will be covered in the next section. Settings here will only be invoked at runtime for the rendering of attributes and parameters that are specified as custom. The VIF automatically handles attributes and parameters that are not specified as custom.

The <automationlibrary> in this particular example is left empty. This is because the VIF will load the implementations of the viewer integrations from a default location for this viewer provider on the client side. As will be discussed later, implementations of viewer integrations, both at the client side and at the server side, are all packaged in a single viewer bundle. The default location for the client side implementations is a designated location within the viewer bundle structure. Nevertheless, this setting allows the viewer integrator to assign an implementation library from a non-default location. This mechanism allows sharing of client side implementations among multiple viewer providers.

The <requesthandler> element in this particular example describes the handlers for the service request that this viewer control requires at runtime. Each handler is placed under a <handlerspec> sub-element. Starting from the top is the handler specification for “documentdownload” which specifies the handler for handling the service request for downloading document content from the server side to the viewer control. The <handlerspec> element comprises 3 sub-elements:
a) The <baseurl> element specifies a URL pattern for downloading document contents. This URL pattern will be used to generate a fully-qualified service URL at runtime to address the service that retrieves the requested document content from the repository and delivers the retrieved document content to the requesting client. When generating a fully qualified service URL, this URL pattern will be combined with runtime context and possibly the design time context in order to form a fully qualified service URL. For instance, if the document ID from the runtime context is a string “1234567890”, the generated fully qualified service URL will look like “/{appname}/vif/document?docID=1234567890” if the viewer does support relative URL, and “http://{server-name}:8080/{appname}/vif/document?docID=1234567890” if the viewer doesn't support relative URL, where “{server-name}” is the IP or domain name, and “{appname}” is the name of the ECM application;
b) The <handler> element specifies the implementation class for handling the request for document content. When the viewer control submits an HTTP request at runtime for document content using the URL pattern specified in the <baseurl> element, the framework delegates the request to the class specified in this element, in this case com.abc.vif.runtime.handler.request.DefaultDocumentHandler. In this particular example, the viewer integrator assigns a default implementation class here to handle the document content downloading requests. Using a default implementation means the viewer integrator doesn't have to implement his own handler class for the viewer provider, thus making the integration effort easier. However, the viewer integrator can override the default behavior by implementing and specifying his own handler class here;
c) The <paramname> element specifies the name of the initialization parameter that the viewer control exposes to allow assignment of the URL for downloading the document content. In this particular case, the initialization parameter is “DocumentUrl” as shown in FIG. 2F. By connecting the <baseurl> and the <paramname>, the VIF is able to automatically generate a service URL and assign the generated URL to the “DocumentUrl” parameter, thus automating the viewer control rendering process.

FIG. 2F shows the content of the <control> element of an exemplary VIP. The “type” attribute specifies the underlying plug-in technology that the viewer control is built upon, in this example the Java Applet. The <attributes> sub-element lists all necessary attributes for this viewer control. The <parameters> element lists all necessary initialization parameters for this viewer control. By looping through the list of attributes and parameters, the VIF is able to automate the control rendering process at runtime. As illustrated in the example, each of the <attr> and <param> sub-elements is followed by a “type” field which allows the viewer integrator to specify how the attribute or parameter will be handled. Several values for the “type” field can be defined in order to simplify and automate the control rendering process:
1) “static” means the VIF control renderer can take the value as it is without any modifications or manipulations. For instance, in the example illustrated in FIG. 2F, after the control rendering, the “archive” attribute will take the value of “xzyviewer.jar” since this attribute is assigned “static” type;
2) “url” means the final value for this viewer attribute/parameter will be generated from the value specified in the URL field. The URL generation process will depend on whether the viewer control supports relative URL. If it does, the final value will be generated in the form of a relative URL; if it does not, the final value will be generated as an absolute URL. The only exception is when the value assigned in the VIP is already an absolute URL. In this case, the attribute/parameter will be treated as “static”; no modification or manipulation will be applied to the value. This arrangement makes the VIP universal, without dependency on individual ECM applications. As shown in FIG. 2F; the value assigned for the “codebase” attribute is “/viewerbundles/xyzviewer-bundle/client-component/xyzviewer” which specifies the location where all resources of this viewer provider reside. After the viewer control rendering, the “codebase” attribute of this Java Applet will have the value of “{appname}/viewerbundles/xyzviewer-bundle/client-component/xyzviewer” with the ECM application name “appname” prefixed to the URL if this viewer supports relative URL, or “http:server-name:8080/{appname}/viewerbundles/xyzviewer-bundle/client-component/xyzviewer”with the HTTP protocol, the app server name “server-name” and ECM application name “appname” prefixed if the viewer doesn't support relative URL;
3) “runtime” allows the VIF to append runtime context to the values specified in the VIP. For instance, the “DocumentUrl” parameter is specified in the “runtime” field in the example illustrated in FIG. 2F. There is no value assigned to this parameter here because a URL pattern is already′ specified in the “documentdownload” request handler. The <paramname> sub-element under the <handlerspec> element links the “documentdownload” request handler to the “DocumentUrl” parameter. The <baseurl> for the “documentdownload” request handler specification is given a URL pattern of “/vif/document” in FIG. 2E. At runtime, the VIF must append the context information to the URL pattern in order to generate a useful URL for the “DocumentUrl” parameter. Context information includes but is not limited to the ID of the document that a user picks to display, and the content type of the document etc. The nature of the generated URL will depend on whether the viewer control supports relative URLs, a value that a viewer integrator can specify in the <relativeurl> element in FIG. 2B. If the viewer control supports relative URL, a relative URL will be generated. Otherwise, an absolute URL will be generated for the “DocumentUrl” parameter.
4) “custom”, which is not shown in FIG. 2F but is desirable to have, means the VIF will delegate the generation of the runtime value for the attribute or parameter to the implementations for the viewer provider. The viewer implementations will be responsible for generating the runtime value. The VIF only uses the result to render the viewer attribute or parameter. The viewer implementation class that handles the “custom” attributes and parameters is specified in the <parameterhandler> element as shown in FIG. 2E. The implementation class specified in this element must implement an interface defined by the VIF so that the VIF can invoke the class at runtime during the process of viewer control rendering. The introduction of the “custom” type allows the viewer integrator to handle special viewer attributes and parameters that are hard to abstract at the framework level. It also allows the viewer integrator to override the default behavior of the parameter handler implemented by the VIF. On the other hand, if a viewer provider doesn't have any custom attributes and parameters, the viewer integrator doesn't have to write any code to handle them, which makes the viewer integration easier.

The VIP is essential for describing a content viewer and the environment that the content viewer is going to operate in. However, the VIP alone is still not sufficient for rendering a viewer control at runtime. Data contained in the VIP must be combined with the runtime context in order to fully render a viewer control at runtime. A runtime context refers to a collection of data that reflects the status of the content (both document and annotations, and possibly other contents) that the content viewer is to display. In a multi-user ECM system, a document from a repository can be viewed by more than one user, possibly at the same time. Each user may have different privileges on the document and the associated annotations. Certain users may be authorized to manipulate the content of certain documents held in the repository. In its simplest form, a runtime context reflects the status of the document and the associated annotations. When a document has been accessed for manipulations by a user, the best practice for an ECM system is to deny other users access to modify the content of the same document, in order to avoid data corruptions. The page modification features should be disabled from the client side. If the current user doesn't have privileges to make annotations, the system should not allow the user to create or modify annotations from within a viewer. This is regardless of whether the viewer provider supports annotations or not. The annotation toolbar, if there is any, should be disabled or hidden altogether from the user.

Another area that affects the rendering of viewer controls at runtime is the context that a designer sets at design time for an instance of the viewer widget. For example, when a designer creates a client page with a viewer widget embedded for an ECM application, the designer may choose not to allow printing from this particular client page, perhaps in accordance with some guidelines of the business. The rendering of the viewer control must honor the settings in the design time context by disabling any print features of the viewer control. This guarantees that the document cannot be printed from any viewer control instance on this particular page of the ECM application. Design time context is optional depending on whether an ECM system supports design time settings for the viewer widget.

Modern content viewers come with packages that contain many artifacts necessary for the distributions and proper functioning of the viewer control at runtime. Such artifacts include the executable code of the viewer control, modules and libraries that the viewer control may depend on, resources and help contents etc. This package is normally self-contained and shipped directly from the vendor of the content viewer. However, the content viewer vendor usually has no knowledge about where and how this package will be deployed to and accessed from an ECM system, nor the runtime environment where the viewer control will be running. Integrations with an ECM system are certainly not contained in this package. This viewer package shipped from a viewer vendor is often referred to as “client components”. With only a few exceptions almost all competitive content viewers include client components. Client components are deployed on application servers from which viewer controls are downloaded. They are then installed on the client side when required before a document can be displayed from within the viewer control. To date, viewer packaging has generally been the concern of viewer vendors, while the deployment of the viewer package is generally the job of the administrators of an ECM system. Viewer vendors and ECM system administrators generally do not concern themselves with packaging and deployment of the executable code and resources for viewer integrations in an ECM system. However, given our objective of supporting multiple viewers in ECM systems, it would be advantageous to combine “client components” together with the implementations and resources for the viewer integrations into a single package that collectively represents a viewer provider in an ECM system. A single bundle would make the handling of viewer providers much easier, with respect both to design time and to runtime. Keeping the integration implementations separate from the “client components” not only increase the difficulties of handling them in the system, but also causes confusion, and even bugs, when integrations and “client components” are mismatched at runtime. Certain embodiments of this invention incorporate the single bundle approach for the packaging and deployment of viewer providers. Each viewer provider has its own viewer bundle that combines the “client components” and the integrations in a single deliverable package. Other embodiments of this invention include a two-bundle approach with one for the server side and another for the client side. The combined package for a viewer provider is hereafter referred to as a viewer bundle.

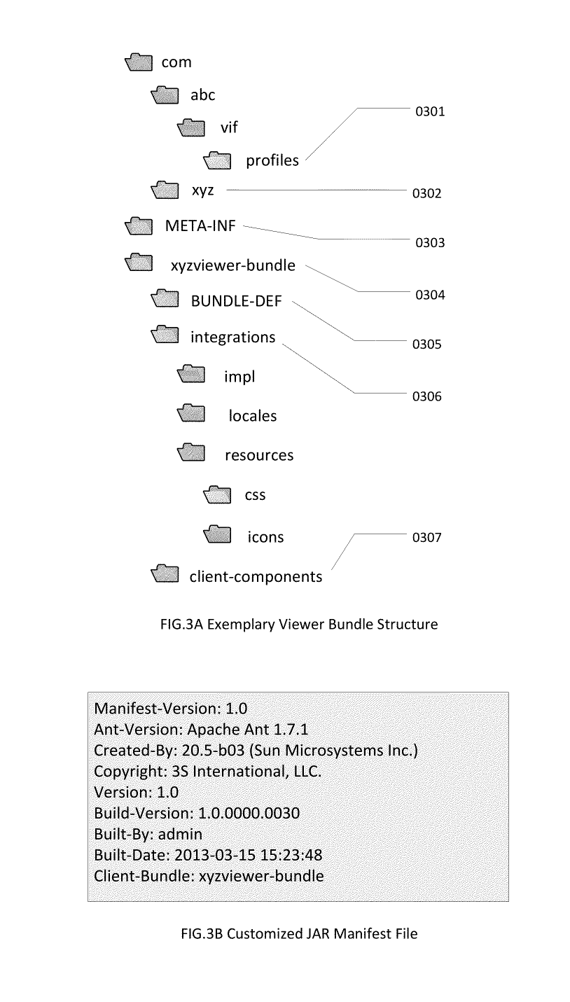

FIG. 3A shows the internal structure of an exemplary viewer bundle jar (Java ARchive) for a content viewer provider named “xyzviewer” integrated in an ECM system named “abc”. Server side integrations, if any, are placed under the com.xyz namespace 0302 as is normally done to package a jar. The VIP for this viewer provider is placed at the com.abc.vif.profiles namespace 0301. This arrangement is for easy access by the VIP from the server side. An alternative approach would be to place the VIP in a different folder where client side integrations reside, which would favor easy access from the client side. In order to accommodate client side integrations and client components, the traditional jar file is customized to include a folder named xyzviewer-bundle 0304 as shown in FIG. 3A. The jar manifest file, MANIFEST.MF located under the META-INF folder 0303, is customized to include a special entry as a pointer to the xyzviewer-bundle folder 0304. It is also a good practice to name this folder with the name of the viewer provider. The customized manifest with a special attribute “Client-Bundle” is shown in FIG. 3B. The value of the special attribute is the name of the folder in the viewer bundle where client side integrations and client components are packaged. The processor of the viewer bundles would use this special attribute not only as an identifier for viewer bundles but also as a pointer to the locations from which resources in the viewer bundle can be accessed. Client side integrations are placed under the integration folder 0306 right under the xyzviewer-bundle folder 0304. Client components are placed under the client-components 0307 folder under the xyzviewer-bundle folder 0304. If there are resources such as icons, CSS styles and locales that are required by the client side integrations, they can be placed under the integration folder 0306 too.

Addressing resources packaged inside a viewer bundle requires the mapping of a URL pattern to the internal structure of the viewer bundle. For example, if the client side needs to access the viewer integration JavaScript file xyzviewer.js placed under the xyzviewer-bundle/integration/impl folder, the client would use a URL like /vif/viewerbundles/xyzviewer-bundle/integrations/impl/xyzviewer.js to address the resource. If the viewer control needs to access a resource named xyzviewer.bin under the client-components 0307 folder, the viewer control uses a URL like /vif/viewerbundles/xyzviewer-bundle/client-components/xyzviewer.bin to address the resource. In these URL examples, /vif/viewerbundles is the URL pattern that is mapped to the viewer bundle service which knows how to locate viewer bundles among many jar files. By looking at the manifest under the META-INF folder 0303 and searching for the special attribute “Client-Bundle”, the viewer bundle service can determine whether a jar file is a legitimate viewer bundle. If yes, the value of the custom attribute can be used to locate xyzviewer-bundle 0304, and hence the files in the folder structures in the viewer bundle. Using a single custom attribute to validate a viewer bundle is primitive. A more solid approach can be achieved by placing a viewer bundle definition file under a special folder, for example BUNDLE-DEF 0305 as shown in FIG. 3A. Sophisticated viewer bundle definitions can be used not only to validate a viewer bundle, but also to implement more features such as the dependency relationships between two JavaScript files and the preloading and compressions of JavaScript files.

With the structure of the viewer bundles defined and a service in place at the server side to retrieve and deliver the artifacts packaged in them, it is up to the viewer integrators to construct the viewer bundles following the access rules set by the VIF. Viewer bundle creation is a development process different from the development of the viewer itself. It's also different from the traditional design time and runtime concepts. It involves developing the viewer integrations, both for the client side and server side, against a specific target ECM system with a framework for viewer integrations, constructing a VIP and packaging the viewer bundle following the rules and folder structures set by the VIF. This process is conceptually parallel to the driver/firmware development for a piece of hardware on the Windows operating system which, in this example, is analogous to an ECM system. In order to support plug-and-play utility of a piece of hardware on the Windows operating system, a driver or firmware must be developed specifically for the piece of hardware so that the hardware will work properly on the Windows operating system. Similar to the driver/firmware development, a viewer bundle must be developed for a given viewer provider to support the plug-and-play functionality of the viewer provider on the specific ECM system. An ECM system without a VIF will not allow plug-and-play of content viewers because the VIF sets the standard for integrating into a specific ECM system and provides necessary support to viewers interacting with a specific ECM system at runtime and design time. Due to the importance of the development process of the viewer bundles, the concept of integration time must be introduced in order to differentiate between design time and runtime for the viewer provider. At integration time a viewer bundle is prepared, developed and tested for a specific viewer provider and a specific ECM system. This process is different from the concept of design time because tasks at integration time will more likely be carried out by viewer vendors, just like drivers and firmware are normally developed by hardware manufacturers, while design time jobs are carried out by ECM customers on site. At design time, viewers are injected into the system and deployed for active use from ECM applications. From the integration perspective, the integration time constitutes the most important step for the integration of the content viewer in the target ECM system. After the completion of the integration process, the viewer bundle can be shipped to customers for deployment. The actual deployment of the viewer bundle should be relatively easy since much of the preparation work has been done. For example, on a Java based ECM application running on the Tomcat application server, it would require simply placing a viewer bundle jar file under the WEB-INF/lib folder of the ECM web application. Switching viewers would only require taking out an existing viewer bundle jar from and placing a new one into the WEB-INF/lib folder.

With the structure of the VIP and viewer bundle finalized, it's time to consider the implementations of the integrations in the VIF. Finalizing a VIP depends on the implementations of the integrations. Implementations of the integrations in the VIF are part of the tasks for the integration time. Implementations for viewer integrations can be divided into two types, implementations for the framework and implementations for each individual viewer. A good VIF has as many implementations on the framework side as possible, while leaving windows for extensions and customizations of the framework for individual viewers. This requires abstracting and modeling as many content viewing features and integration points as possible against a given ECM system. Detailed content viewing requirements with respect to an ECM system should have great impact on the architecture of the design and implementations of the VIF. Different ECM systems may require different architectures for the VIF. Clear separation and standardizations of features should be implemented by integrations and it must be decided what features should be implemented by viewer providers and what features should be implemented by the UI framework that provides the infrastructure for document display among other components of the ECM application at the client side. Following is a list of viewer integration points as examples:
a) Viewer control rendering
b) Viewer automations
c) Event handling
d) Interactions with other widgets and components on the same HTML page
e) Document display and versioning
f) Document importing
g) Annotations and redactions
h) Page navigations from within the viewer control, as well as from outside
i) Search and highlighting
j) Printing from a list of documents
k) Auditing of end user activities from within the viewer control
l) Viewer control reuse
m) Page modifications
n) Back end services

This list reflects some common content viewing features that an ECM system would require. However, as additional content viewing requirements are added, new integration points may have to be identified and added into the list above. For example, if an ECM system requires a document comparison feature, document comparison must be added into the list above since this new feature requires the display of two documents on the client, side-by-side. This feature would require the viewer integration framework at the client side taking two document IDs that the user picks and instantiating one or more viewers to display the selected documents. Addition of such a new integration feature would also require addition of a new item under the <system> element as shown in FIG. 2B so that the VIF will be able to differentiate viewer providers that support document comparison from those that don't.

No matter how many viewer integration features and integration points we come up with, viewer integrations only happens in 3 different areas: client side, server side and in between.

With the huge success of the client-server architecture for large systems, modern ECM systems all run viewer controls at the client side. A couple of things make client side integrations preferable. First is the requirement for a content viewer to display dynamic documents from the back-end repository of an ECM system. Dynamic rendering of the viewer controls from the content viewer integrations best satisfies this requirement, given that documents of various file formats need to be handled in different situations from time to time possibly involving more than one viewer providers. Although there are only two options depending on the presentation framework that the overall UI framework the ECM system is built upon, viewer control rendering at the client side is becoming more prevalent than the server-side rendering options, because of the increasing computing power of client machines. Listed below are a few exemplary interface methods that standardize the viewer control rendering process at the client side in JavaScript. The VIF provides default implementations for these methods; however a viewer integrator can choose to override them in order to meet specific needs of the viewer control rendering:
1) function preRender (json)
   This interface method takes a data package in JSON format as input and returns dynamic HTML/JavaScript code necessary for the viewer control. The VIF provides a default implementation of this method which simply returns an empty string. The viewer integrator can choose to override the default behavior. Typical implementation of this method is to generate JavaScript event handlers to handle events that the viewer control may raise at runtime. Alternatively, this method can output some HTML content, for example a toolbar, so that it appears in front of the viewer control.
2) function postRender (json)
   This interface method takes a data package in JSON format as input and returns dynamic HTML/JavaScript code necessary for the viewer control. The VIF provides a default implementation of this method which simply returns an empty string. The viewer integrator can choose to override the default behavior if the viewer integrator wants to append dynamic HTML/JavaScript to the viewer control.
3) function renderControl (tagName, attrList, paramList)
   This interface method takes a string for identifying the technology of viewer control (Applet, object etc.), a list of viewer attributes and a list of viewer parameters. This method returns dynamic HTML code for the rendering of the viewer control. The VIF provides a default implementation of this method which renders the viewer control with the provided name, attributes and initialization parameters. Size, location and styles are missing from the input because they are considered attributes that are managed by the UI framework of the entire webpage.

The second factor tending to make client-side implementations preferable is the interaction between a viewer control and other widgets and components displayed side-by-side on the same client. For example, a widget that displays a list of documents may sit side-by-side with a viewer control, and users expect to see the viewer control displaying the current document as the user navigates or scrolls through the list of documents. Another example is a thumbnail control that displays all the pages from a document in scaled down resolutions and size. If the thumbnail control is external from the viewer control, and placed side-by-side by the viewer control on the same client, users expect synchronization between the thumbnail control and the viewer control for page display. Providing an external thumbnail control at the integration level is necessary for a viewer control that doesn't come with a built in thumbnail control. However, content viewers are different in many ways. They are built up on different technologies, they have different sets of initialization parameters, they have different viewer automation layers and events and even different event mechanisms. They might be different in the way they communicate with the server side. Without some level of standardization of the interactions between a viewer control and the hosting client, the VIF is not doing the best it can to simplify the integrations. Listed below are some interface methods that standardize the interactions between the VIF and the viewer control. Interactions between external widgets and the viewer control are delegated by the VIF. The VIF also provides default implementations for these methods. However, to make the integration really useful, the viewer integrator must implement these methods since they are tailored for the event handling and viewer control automations of a specific viewer control:
1) function handleViewerEvent (eventID, eventData)
   This interface method is the handler for events fired from the viewer control. It takes event ID and event Data as input. It performs necessary operations in response to some important events fired from a viewer control. A good example is when a page-navigation event is triggered from the viewer control as a user navigates pages from within the viewer control. If there is a thumbnail control displayed side-by-side with the viewer control, we want the thumbnail control to synchronize with the current page. The implementation of this method needs to catch the page navigation event, and invoke the automation method on the thumbnail control to move the focus of the thumbnail display to the current page.
2) function handleHostEvent (eventID, eventData)
   This interface method handles events triggered by other widgets or controls displayed side-by-side with the viewer control on the same client. By looking at the eventID, the client-side integrations for a viewer provider can decide how to react to the event. This interface method gives the hosting client a way of notifying the viewer control for activities on the other widgets or control.
3) function fireEvent (eventID, eventData)
   This interface method fires events that may change the status of other widgets and controls displayed side-by-side on the same client. Most likely, it will be implemented at the framework level; viewer integrations can use this method to notify widgets and controls of the activities from within a viewer control. Responses to this event are determined by the implementations of other widgets and controls.
4) function getPageCount( )
   This interface method returns the number of pages of the document currently displayed in the viewer control. The way that number is obtained depends on the actual implementation. One efficient implementation is to query the viewer control for the number of pages.
5) function next Page ( )
   This interface method switches the viewer control to the next page of the document. This is one of the viewer automation methods that the viewer integrator must implement. Viewer automation methods give the hosting client a way of controlling the control that the viewer control has over activities on other widgets or controls. A typical usage of this method from the VIF is when a user navigates pages from within a thumbnail control that is displayed side-by-side with the viewer control. It may be desirable to synchronize the focus of the current page at the viewer control. The VIF calls the implementation of this method to switch the viewer control to the current page.
6) function prevPage ( )
   This interface method switches the viewer control to the previous page of the document. This is another viewer automation method.
7) function gotoPage (pageIndex)
   This interface method switches the viewer control to a specified page of the document. This is another viewer automation method.
8) function loadDocument (docID, contentType)
   This interface method switches the viewer control to display a document from a document ID. This method takes document ID and content type as input. This is one of the viewer automation methods that the viewer integrator needs to implement in order to support the control reuse feature. When the viewer control is displayed side-by-side with a widget that displays a list of documents, user selection of a document from the list triggers the display of the selected document in the viewer control. It is desirable if the existing viewer control can be reused for the display of documents as a user navigates in the document list.
9) function loadFile (filePath, dosExt)
   This interface method makes the viewer control display a file from a local file system. This method takes the file path and the DOS extensions of the document as input. Display of local files is desirable when a user needs to import a local file into the ECM system. This is another viewer automation method.
10) function loadDocumentURL(docUrl)
   This interface method makes the viewer control display a document from a URL. This method is useful for implementing the support of the fallback mechanism. If there are more than one channels of delivering document content from the ECM repository, a fallback mechanism is desirable in order to guarantee the display of a document. When one document URL has failed, the VIF switches to the next URL that points to the same document, and commands the viewer control to display it. This is another viewer automation method.
11) function loadAnnotations (annoUrl)
   This interface method makes the viewer control display annotation contents from a URL. This method is useful for implementing the support of the fallback mechanism on the display of annotations. This is another viewer automation method.
12) function printDocument ( )
   This interface method makes the viewer control print the entire document in display. This method is useful for implementation of the printing feature from outside of the viewer control. For example, it may be desirable to give end users the option to right click a document and choose the Print context menu from within a widget that displays a list of documents. This is another viewer automation method.
13) function printPage (pageIndex)
   This interface method makes the viewer control print a specific page of the document in display. This method takes the page index as input. This is another viewer automation method.
14) function auditActivity (activity)
   This interface method makes a request to the server side to make an audit entry for user activities within a viewer control. For example, when a user prints the current document that is displayed in the viewer control the server side may not be aware of this activity. To audit such activities, the viewer integrations can call this method to make an entry in the audit trail table at the server side. This method serves the audit trail requirement for all viewer providers. It will more likely be implemented at the framework level than at the individual integration level.
15) function searchHighlight (text)
   This interface method makes the viewer control search and highlight text in the document in display. This method takes a string representing the text to search for and highlights it in the viewer. This is another viewer automation method.

A client-side integration framework is desirable for handling the interactions between a viewer control and the hosting client, as well as communications between the client side and the server side. The introduction of the viewer widget entity that encapsulates a client-side integration framework best meets our objective for handling multiple viewer providers while minimizing the integration efforts.

The use of the viewer widget concept is not only helpful for separating design-time behavior from run-time behavior, but also helpful for separating the responsibilities of the integration framework and integration implementations for viewer providers. The viewer widget is a framework level entity that interfaces with the hosting client. The positioning, size and style of a viewer control in a client are determined by the framework, and thus should be controlled at the viewer widget level. The viewer widget is the preferred object to capture and hold the settings for design-time context. However, viewer control rendering is viewer-control specific, thus should be done at a lower level. A single viewer widget that is responsible for all content viewing features and the instantiation of all content viewers is the approach or indirect viewer integrations in certain embodiments of this invention. An ECM system has only one entity to deal with from the perspective of content viewing, either from design time or from runtime. Creating a widget for each individual content viewer is still a direct integration approach because when switching of content viewers is required, all pages with the viewer widget embedded must be redesigned and configured, which goes against the idea of plug-and-play of content viewers from an ECM system.

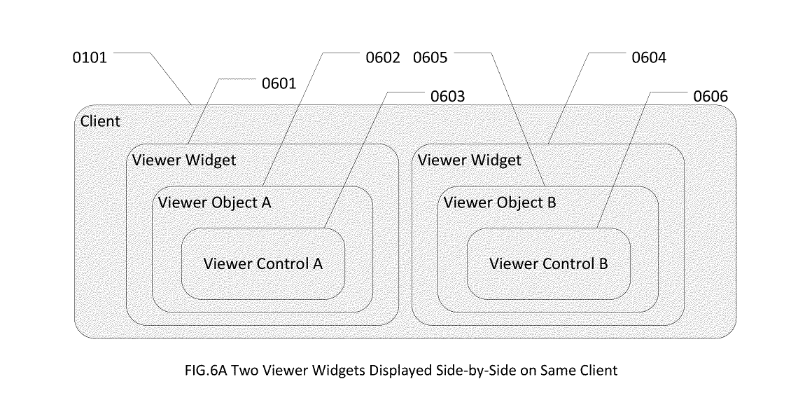

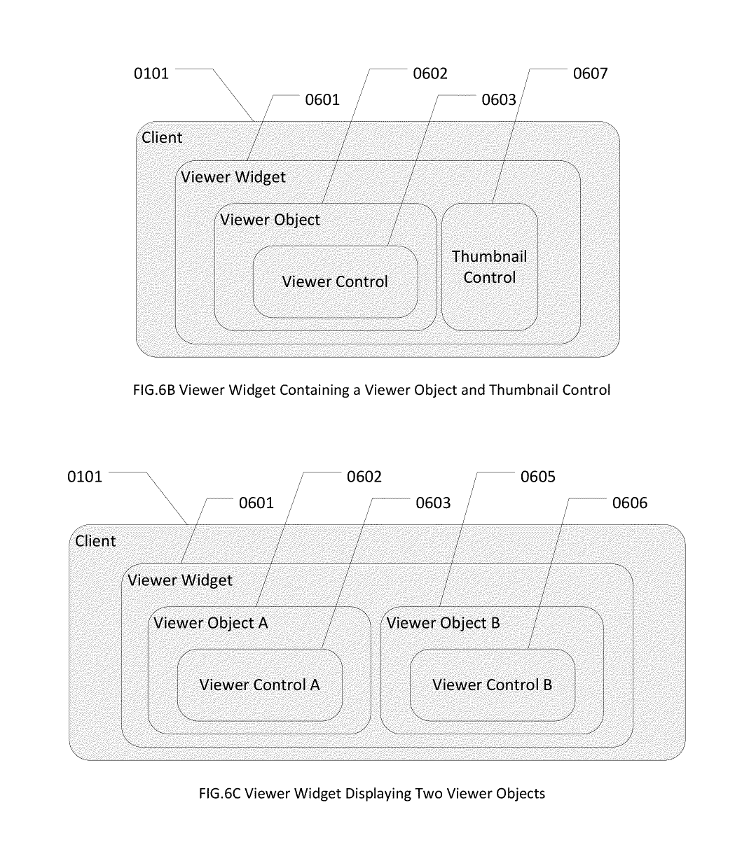

FIG. 6A illustrates two viewer widgets displayed side-by-side on the same Client 0101. Viewer Widget 0601 is an instance of the viewer widget which contains a single Viewer Object A 0602. Viewer Object A 0602 is an instance of the viewer object which implements the standard interface described above for viewer provider A. A viewer object wraps around a single viewer control from a viewer provider. The viewer object renders the viewer control contained inside, and standardizes the interactions between viewer controls and the hosting client. Viewer control rendering involves dynamically creating a viewer control, establishing the interactions between the viewer control and the hosting client, and establishing the communications with the services that the viewer control may require at runtime from the server side. Similarly, Viewer Widget 0604 is another instance of the viewer widget containing a single Viewer Object B 0605 which is an instance of the viewer object that implements the standard interface for Viewer Control B 0606. Viewer Object A 0602 and Viewer Object B 0605 are two instances of the viewer object. They may or may not be implemented for the same viewer provider. However, from the viewer widget perspective, they all look the same due to the standard interface they all implement.

There are pros and cons to giving an instance of the viewer widget the same behaviors for design time and runtime. Since a design tool may not have connections to the repository of the ECM system at design time, or the designer may not have a design tool at all to start with the construction and building of an ECM application, an instance of the viewer widget is not likely going to display live documents from the repository at design time. Having “what you see is what you get” is ideal for the designer and end users to see the same behavior of the viewer widget. However, with the huge differences among content viewing technologies, the effort for implementing the full blown content viewing features in design time tools may not merit the benefits of achieving WYSIWYG for a viewer widget, because design tools typically have completely different user interfaces from that for end users.

FIG. 6B illustrates another implementation or configuration of the viewer widget. Viewer Widget 0601 is embedded in Client 0101, which contains a single Viewer Object 0602 and Thumbnail Control 0607. Thumbnail Control 0607 is a separate entity from Viewer Control 0603. Conceptually, Thumbnail Control 0607 is part of Viewer Widget 0601 which is the entity responsible for display documents from an ECM system. The purpose of introducing an external thumbnail control is to ensure uniform end user experiences for all viewer providers with some of them may not have an embedded thumbnail control. An external thumbnail control also brings extra values to the viewer widget. For example, document page manipulation features can be implemented into the thumbnail control from which end users can drag and drop document pages in order to delete, insert, extract and reorder pages from a document. The display of Thumbnail Control 0607 is optional.

FIG. 6C illustrates yet another implementation or configuration of the viewer widget where Viewer Widget 0601 contains two viewer objects: Viewer Object A 0602 and Viewer Object B 0605. This configuration can be useful for document comparison scenarios where Viewer Control A 0603 and Viewer Control B 0605 display two separate documents respectively. Viewer Control A 0603 and Viewer Control B 0605 can be from different viewer providers or from the same viewer provider. This configuration ensures uniform end user experiences with all viewer providers even though some viewers natively support document comparison and others don't. For viewer providers that support document comparison, the initialization of Viewer Widget 0601 results in a single viewer object that displays two documents side-by-side inside the viewer control. For viewer providers that do not support document comparison, the two documents are passed on respectively to two viewer controls side-by-side.

Viewer integration at the server side is also beneficial, even if the viewer controls are not going to be rendered at the server side. It is desirable to have an integration framework and API (Application Programming Interface) at the server side. Some reasons this configuration is desirable are: i) document meta data that effect the display status of the viewer control (for example, permission codes controlling whether or not a user has permission to annotate the document) is normally stored at the server side in the ECM repository; ii) document URLs and annotation content URLs need to be generated at the server side; iii) various requests and post-backs from viewer controls need to be handled at the server side, possibly differently for different viewer providers; and iv) the majority of the content management services are provided at the server side, just to name a few. Several interface methods by which viewer integrations and customizations may be implemented are listed below:
i. IViewerParameterHandler
   This interface defines methods for handling viewer attributes and parameters of “custom” type specified in a VIP. By providing the implementation class of this interface in the VIP, the viewer integrator declares that all “custom” attributes and parameters of the viewer control will be handled by this class when it comes to the rendering of the viewer control. The XyzViewerParameterHandler class specified in the <parameterhandler> element in FIG. 2E must be an implementation class of this interface.
ii. IDocumentContentHandler
   This interface defines methods for handling the retrieval and delivery of document contents and saving uploaded document contents to the ECM repository. A default implementation of this interface is provided by the VIF. However, the viewer provider can choose to override the default behavior by implementing and providing its own implementations.
iii. IAnnotationContentHandler
   This interface defines methods for handling the retrieval and delivery of annotation contents and saving uploaded annotation contents to the ECM repository. A default implementation of this interface is provided by the VIF. However, the viewer provider can choose to override the default behavior by implementing and providing its own implementations.
iv. IAuditTrail Handler
   This interface defines a method for making audit trail entries for user activities from within viewer controls. A default implementation of this interface is provided by the VIF. However, the viewer provider can choose to override the default behavior by implementing and providing its own implementations.
v. IViewerReuseHandler
   This interface defines a method for reusing the viewer control to display another document. A default implementation of this interface is provided by the VIF. However, the viewer provider can choose to override the default behavior by implementing and providing its own implementations.
vi. IPageInsertionHandler
   This interface defines a method for inserting a document into a specified page position of another document. A default implementation of this interface is provided by the VIF. However, the viewer provider can choose to override the default behavior by implementing and providing its own implementations.
vii. IPageDeletionHandler
   This interface defines a method for deleting one or more pages from a document. A default implementation of this interface is provided by the VIF. However, the viewer provider can choose to override the default behavior by implementing and providing its own implementations.
viii. IPageExtrationHandler
   This interface defines a method for extracting one or more page from a document to form a new document. A default implementation of this interface is provided by the VIF. However, the viewer provider can choose to override the default behavior by implementing and providing its own implementations.
ix. IPageReorderHandler
   This interface defines a method for reordering pages within a document. A default implementation of this interface is provided by the VIF. However, the viewer provider can choose to override the default behavior by implementing and providing its own implementations.
x. IDocumentMergeHandler
   This interface defines a method for merging two or more documents to form a new document. A default implementation of this interface is provided by the VIF. However, the viewer provider can choose to override the default behavior by implementing and providing its own implementations.

Further description and explanation of the implementations of the IAnnotationContentHandler interface is also required. Content viewers are different in many ways. As described above, they are built up on different technologies, they have different sets of initialization parameters, they have different viewer automation layers and events and even different event mechanisms. They also generate different annotation data as revealed in patent application Ser. No. 13/591,396 which is incorporated by reference, due to lack of standards on the format of annotation contents. Annotation contents created by different viewers are not compatible with each other. One content viewer simply cannot read and display the annotation contents generated by other content viewers. The incompatibility of annotation data between content viewers causes potential issues in an ECM system that supports multiple content viewers. When a user switches from one viewer to another, annotations a user created in one viewer may not display in another viewer. This is a data loss issue from the end user's perspective, even though the annotation contents are still stored in the ECM system's repository. If redactions are applied in one content viewer, the incompatibility of annotation data will evolve into security issues since the redactions that are supposed to cover areas of documents will not be displayed after switching viewers. The covered areas with sensitive information are now wide open to everyone using a different viewer.

Data interoperability between the content viewing and other components of an ECM system is another problem that may result from annotation incompatibility. One example is the text search facility. In an ECM system that supports one or more viewers, the ability of searching into annotation contents with different data formats is greatly limited, if not technologically impossible. Today, all annotation data formats are proprietary to viewer vendors. Some of them are well documented and publicized. Some of them are held privately in binary formats. Unless all viewer vendors and ECM system vendors agree to a standardized annotation format, data interoperability and transparency is hard to achieve for an ECM system.

By implementing the IAnnotationContentHandler interface utilizing the on-the-fly annotation conversion method disclosed in patent application Ser. No. 13/591,396 which is incorporated by reference, one can resolve the problems caused by annotation incompatibilities. An annotation data format that is transparent to other components of the ECM system could be devised. All annotation contents will be stored in the ECM repository in this storage format. From the annotation retrieval method of the IAnnotationContentHandler interface, each implementation for a specific viewer provider is required to retrieve annotation contents from the repository in the storage format, convert the retrieved annotation contents from the storage format to the format native to the viewer provider, and then deliver the converted annotation contents to the requesting clients. Also, from the annotation saving method of the IAnnotationContentHandler interface, each implementation for a specific viewer provider is required to convert the uploaded annotation contents from the format that is native to the viewer provider to the storage format, and then save the converted annotation contents into the ECM repository. This way, one can guarantee that all annotation data stored in the ECM repository is neutral to all viewer providers in the system, and transparent to all components. One not only prevents the annotation/redaction data loss issue from happening, but also maintains the annotation data transparency across the entire ECM system.

Aside from interfaces and API, a set of standardized content viewing services are also desirable for simplifying viewer integrations. Following is a list of services that the client side VIF as well as viewer controls can invoke directly for various operations at the client side. Implementations of these services can be based on either REST or XML WebService. There is almost exact one-to-one correspondence between the services and the interface definitions above, which allows viewer integrators to override default implementations of the interfaces in order to achieve behaviors different from the default implementations.
a) Control initialization (URL pattern: /vif/initialization)
   This service collects the information from the ECM repository for the rendering and initialization of a viewer control. It invokes the implementation of the IViewerParameterHandler Interface in order to generate dynamic values for viewer control attributes and parameters that are specified as “custom” type. Depending on the design decisions, the implementation of this service can be responsible for the rendering of the viewer control, or simply returning the collected data to the client side.
b) Document content downloading (URL pattern: /vif/document)
   This service handles requests from the client side for downloading document content. This service delivers the requested document content from the application server. If there are other content delivery mechanisms available, this service only serves as the fallback content delivery vehicle. This service invokes the implementation class of the IDocumentContentHandler interface so that viewer providers get the chance to override the default behavior provided by the VIF. The URL pattern of this service is assigned to the “documentdownload” handler in <environment> settings of the VIP as shown in FIG. 2E.
c) Document import (URL pattern: /vif/importdocument)
   This service handles requests from the client side for importing documents into the ECM repository from within the viewer control. It invokes the implementation class of the IDocumentContentHandler interface so that viewer providers get the chance of overriding the default behavior provided by the VIF. The URL pattern of this service is assigned to the “documentupload” handler in the<environment> settings of the VIP as shown in FIG. 2E.
d) Document content versioning (URL pattern: /vif/savedocument)
   This service handles requests from the client side for uploading document content to the server side to create a new version. This service invokes the implementation class of the IDocumentContentHandler interface so that viewer providers get the chance of overriding the default behavior provided by the VIF.
e) Annotation content downloading (URL pattern: /vif/annotation)
   This service handles requests from the client side for downloading annotation content by delivering the requested annotation content from the application server. If there are other content delivery mechanisms available, this service only serves as the fallback content delivery vehicle. This service invokes the implementation class of the IAnnotationContentHandler interface so that viewer providers get the chance to override the default behavior provided by the VIF. The URL pattern of this service is assigned to the “annotationdownload” handler in the <environment> settings of the VIP as shown in FIG. 2E.
f) Annotation content uploading (URL pattern: /vif/saveannotation)
   This service handles requests from the client side for uploading annotation content to the server side to either modify existing or create new annotation content, and associate the annotation content with the document. This service invokes the implementation class of the IAnnotationContentHandler interface so that viewer integrators get the chance of overriding the default behavior provided by the VIF. The URL pattern of this service is assigned to the “annotationupload” handler in the <environment> settings of the VIP example as shown in FIG. 2E.
g) Page deletion (URL pattern: /vif/deletepages)
   This service handles requests from the client side for deleting one or more pages from a document, by invoking the implementation class of the IPageDeletionHandler interface.
h) Page insertion (URL pattern: /vif/insertpages)
   This service handles requests from the client side for inserting a document into a specified page position of another document, by invoking the implementation class of the IPageInsertionHandler interface.
i) Page extraction (URL pattern: /vif/extractpages)
   This service handles requests from the client side for extracting one or more pages from a document and forming a new document, by invoking the implementation class of the IPageExtractionHandler interface.
j) Page reordering (URL pattern: /vif/reorderpages)
   This service handles requests from the client side for reordering document pages in a document, by invoking the implementation class of the IPageReorderHandler interface.
k) Document merge (URL pattern: /vif/mergedocuments)
   This service handles requests from the client side for merging two or more documents and forming a new document, by invoking the implementation class of the IDocumenMergeHandler interface.
l) Audit trail (URL pattern: /vif/audittrail)
   This service handles requests from the client side for making audit trail entries for user activities from within viewer controls, by invoking the implementation class of the IAuditTrailHandler interface.
m) Control reuse (URL pattern: /vif/reusecontrol)
   This service handles requests from the client side for reusing the viewer control to display another document, by invoking the implementation class of the IViewerReuseHandler interface.
n) Viewer bundle service (URL pattern: /vif/viewerbundles)
   This service handles requests from the client side for executable and resources packaged in viewer bundles. Viewer integrators can address the resources in the viewer bundles programmatically from the integration implementations or statically from the VIP as shown for the “codebase” attribute in FIG. 2F.

The last area of content viewer integrations is in between the client and the server. “In between” is used to name the third area of viewer integrations because no matter how well the integrations are abstracted, such abstraction only covers the common integration points that suit the common features from known viewer providers. There are always new features, new viewer providers and new content viewing requirements that may not fit well into the model. It is crucial to allow viewer integrators to extend the VIF by creating new service entry points in order to cover features that require not-so-common integrations. For example, a viewer integrator should be able to create a new service with a new URL pattern such as /vif/newservice, and make use of this new service from the client side implementations of the viewer provider. The objective is to allow extensions to a VIF either at the client side, or at the server side or both without having to change the existing code for the framework.

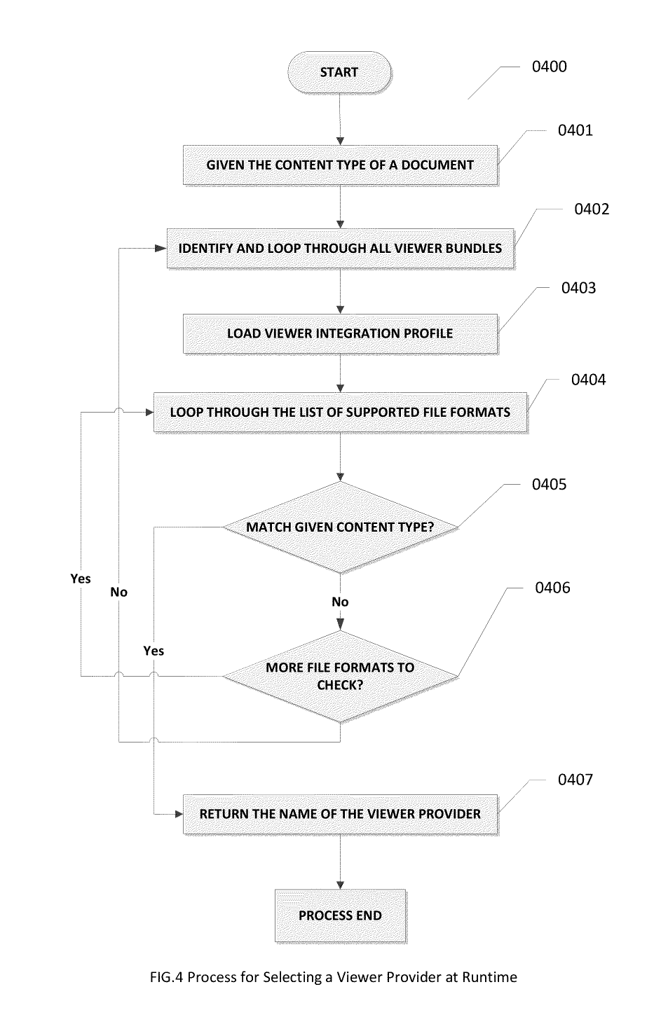

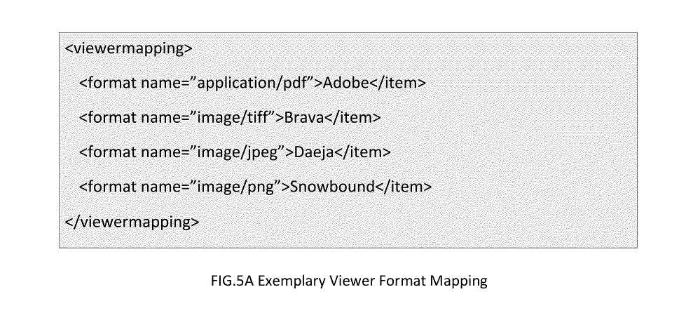

For an ECM system deploying multiple viewer bundles, the VIF must be able to pick a viewer provider from among others for a given document that a user chooses to display at runtime. FIG. 4 shows a procedure for selecting a viewer provider from many to display a given document at runtime. The procedure starts from GIVEN THE CONTENT TYPE OF A DOCUMENT 0401. Every document has a content type that identifies the data format of the document. When a document is imported into the ECM repository, it is assigned a short string to describe the content type of the document. A common approach for identifying the content type of a document is to use the MIME type. However, other strings can also be used to identify the content type. When a user picks a document to display at runtime, the content type of the document can serve as the key for identifying and locating a viewer provider. With one or more viewer bundles deployed in the system, the IDENTIFY AND LOOP THROUGH ALL VIEWER BUNDLES 0402 step enumerates and loops through all viewer bundles from many jar (Java ARchive) files. The LOAD VIEWER INTEGRATION PROFILE 0403 step loads the VIP from each viewer bundle. Relying on the fact that each VIP has the <formats> section that lists all file formats that each deployed viewer provider supports, the LOOP THROUGH THE LIST OF SUPPORTED FILE FORMATS 0404 step loops through the file formats that are supported by the deployed viewer providers. The MATCH GIVEN CONTENT TYPE 0405 step checks whether a file format from the list matches the given content type. If the file format matches the given content type, the procedure exits out of the loop and proceeds to the RETURN THE NAME OF THE VIEWER PROVIDER 0407 step, and return the name of the viewer provider which can then be used for the instantiation of the viewer control. If the file format does not match the given content type, the procedure proceeds to MORE FILE FORMATS TO CHECK 0406 step to check whether there are more file formats to check from the list. If there are still more file formats to check, the procedure proceeds to the LOOP THROUGH THE LIST OF SUPPORTED FILE FORMATS 0404 step again to check for the next file format. If there are no more file formats to check, the procedure proceeds to the IDENTIFY AND LOOP THROUGH ALL VIEWER BUNDLES 0402 step to look into the next viewer bundle. This procedure goes on until a matching file format is found. If there is no match found, an exception should be triggered to warn the user that there are no viewer providers in the system that is able to display the document. The advantage of this mechanism is that it is automatic and simple. There is no need for other configurations to help select a viewer. Furthermore, the deployment of the viewer bundles becomes very easy, by simply dropping the viewer bundle and letting the VIF do the rest automatically. However, the downside of this mechanism is that if there are many viewer bundles deployed in the system and each supports many file formats, it may take some time to locate the right viewer provider, and it is always the first viewer provider that matches the given content type that gets picked.

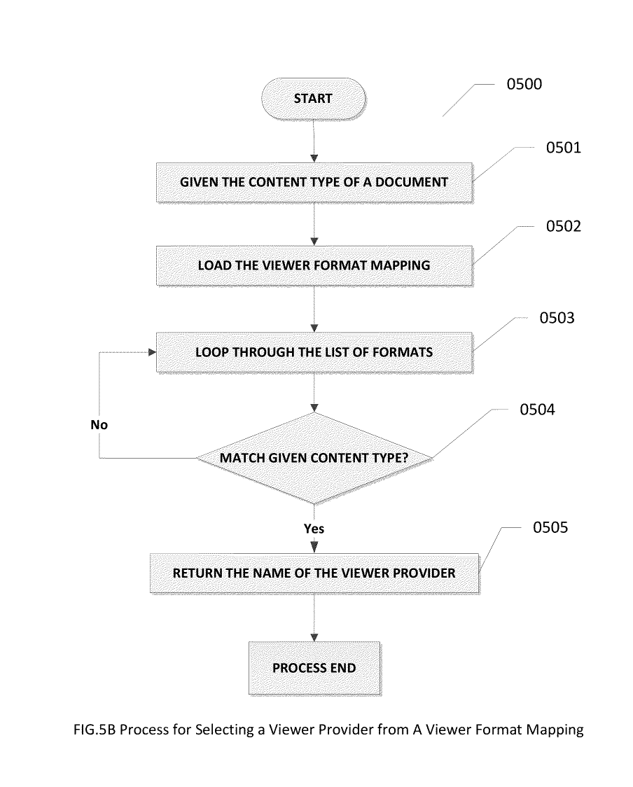

FIG. 5A and FIG. 5B show an alternative approach for selecting a viewer provider at runtime. By having a viewer format mapping file as shown in FIG. 5A, the VIF can look for the name of the viewer provider that is mapped to the given file format at runtime. The content of this can be constructed either manually or automatically from a designer tool or application builder, and then placed in a known location that the VIF can access at runtime. FIG. 5B shows the procedure of selecting the viewer provider from the viewer format mapping at runtime. The procedure starts from the GIVEN THE CONTENT TYPE OF A DOCUMENT 0501 step by taking a string identifying the content type of the document to display. Then the procedure proceeds to the LOAD THE VIEWER FORMAT MAPPING 0502 step to load the viewer format mapping from the known location. Then at the LOOP THROUGH THE LIST OF FORMATS 0503 step, the procedure loops through the list of file formats in the viewer format mapping file, and compares the file format from the list to the given content type at the MATCH GIVEN CONTENT TYPE 0504 step. If the file format matches the given content type, the procedure exits out of the loop and proceeds to the RETURN THE NAME OF THE VIEWER PROVIDER 0505 step and returns the name of the viewer provider which can then be used for the instantiation of the viewer control. If the file format does not match the given content type, the procedure proceeds to the LOOP THROUGH THE LIST OF FORMATS 0503 step again to look into the next format in the list. This loop continues until a match is found or the end of the list is reached. If at the end of the list there is still no match found, an exception should be triggered to notify the user that no viewer providers are available to handle the content type of the document. This approach is more effective than the previous one since there is only one list to loop through in order to find the viewer provider. However efficiency comes with some consequences. Since the viewer format mapping file is external to all viewer bundles, it will be necessary to sync up and refresh the viewer provider names when new viewer providers are added into the system or when old viewer providers are removed from the system. An application designer tool or application generator are the ideal location for adding and removing viewer bundles from the system while keeping the viewer format file synchronized and up to date with the viewer bundles deployed in the system.

In addition to the two approaches described above, other sophisticated and fine-tuned mechanisms have been proposed. For example, the first approach described above can be fine-tuned by selecting the viewer provider not only from the supported file formats, but also from the system attributes listed in the <system> section and/or the <enablement> section of the VIP as shown in FIG. 2B. This way, the selected viewer provider is able to display the document in specific content viewing scenarios. A good example of a content viewing scenario is the importing of local files. A viewer provider that is able to display documents in the PDF file format might not be able to display a local PDF file. If the criteria for selecting a viewer provider at runtime are simply the file format, the selected viewer provider might not support the display of local files. By further looking into the <localfile> element from the <system> section, it can be assured that the selected viewer provider displays local files in the document import use case.

What is claimed is:

1. A computer software framework for content viewer integrations in a content management system comprises:
A plurality of viewer providers each identified by a unique name externally and by a viewer integration profile internally, and each having a viewer bundle with all artifacts that are related to the viewer provider packaged inside;
A plurality of viewer objects each representing the integrations in a content management system at the client side for a unique viewer provider;
A single location for viewer deployment in a content management system;

2. The computer software framework according to claim 1 wherein said viewer integration profile comprises structured data for rendering a viewer control at runtime;

3. The viewer integration profile according to claim 2 wherein said structured data comprises one or more of the following:
A setting for indicating the content viewing technology that a viewer control is based upon, such content viewing technology including but not limited to ActiveX, Java Applet, HTML;
Settings for attributes and parameters required by a viewer control, and means for associating each attribute or parameter with a type string that guides the viewer control rendering functions to generate the runtime value for the corresponding attribute or parameter respectively;
Settings for the file formats that the viewer provider supports display of;
Settings for specifying URL patterns for the services at the server side that the viewer control and the viewer integrations at the client side may require;
Settings for specifying viewer control integration implementations to be invoked by the framework at runtime;
Settings for specifying other system wide attributes that may affect the rendering of the viewer control at runtime;

4. The computer software framework according to claim 1 wherein said viewer bundle comprises a predefined internal structure for the contained artifacts to be addressed by the combinations of the name of the folders, the name of the sub-folders and the name of the artifacts;

5. The viewer bundle according to claim 4 further comprises definitions that define the internal structure of the viewer bundle;

6. The viewer bundle according to claim 5 further comprises functions for differentiating viewer bundles from other bundles that are not following the definition and structure of viewer bundles;

7. The viewer bundle according to claim 4 wherein said artifacts that are related to a viewer provider include but are not limited to client side integration implementations, libraries and static resources required by client side integration implementations, server side integration implementations, static resources required by the server side integration implementations, a viewer integration profile, and optionally executable of the viewer control and libraries that the viewer control depends on;

8. The viewer bundle according to claim 7 further comprises splitting said viewer bundle into a client bundle and a server bundle with the server bundle containing artifacts that run and are consumed by the server side, and the client bundle containing artifacts that are downloaded to the client side before being executed or consumed at the client side;

9. The computer software framework according to claim 1 wherein said viewer object implements a standard programmable interface at the client side;

10. The standard programmable interface at the client side according to claim 9 has a default implementation that can be shared by all viewer providers and overridden by the implementations for a specific viewer provider;

11. The viewer object according to claim 9 further comprises a viewer control;

12. The viewer object according to claim 11 further comprises one or more of the following:
Function for dynamically rendering a viewer control given a document to display at runtime;
Function for wiring up the events fired from within the viewer control;
Function for firing events that may affect the display status of other controls on the same hosting client;
Function for invoking methods published by the viewer control;
Function for invoking remote services for communications between the client side and the server side;

13. The viewer control rendering functions according to claim 12 comprise one or more of the following:
Function for generating service URLs from URL patterns set in viewer integration profile, combining with the data in runtime context and optionally the data in design time context;
Function for altering the values for attributes and parameters of the viewer control set in viewer integration profile, according to the associated type string and runtime context and optionally design time context;
Function for creating and instantiating the viewer control;
Function for embedding an instance of viewer control into a container in the hosting client;
Function for establishing interactions between the viewer control and the hosting client;
Function for establishing communications between the viewer control and the services at the server side;
Function for requesting the initialization values for the viewer control from the server side;

14. The viewer control rendering functions according to claim 13 comprises:
Function for rendering viewer controls at the client side;
Or function for rendering viewer controls at the server side;
Or functions for rendering viewer controls partially at the server side and partially at the client side;

15. The computer software framework according to claim 1 further comprises a viewer widget that one or more instances of the viewer widget can be placed on a hosting client;

16. The viewer widget according to claim 15 comprises runtime behaviors and optionally design time behaviors, that each instance of the viewer widget comprising one or more viewer objects and optionally other controls;

17. The viewer widget according to claim 16 further comprises one or more of the following:
Function for setting the location, size and the style of an instance of the viewer widget on the hosting client;
Function for interacting with the hosting client with interactions including but not limited to firing events to the hosting client from within the viewer widget, intercepting events fired from other widgets and controls displayed on the same hosting client, invoking methods published by the viewer widget from the hosting client;
Function for determine which viewer object to instantiate given a document to display at runtime;
Function for dynamically instantiating viewer objects and other controls, and positioning them side-by-side according to a predefined layout;
Function for invoking methods published from the contained viewer object;
Function for intercepting events fired from the contained viewer object;
Function for invoking remote services, including but not limited to collecting data from the server side for deciding which viewer provider to handle a given document;
Function for downloading artifacts from the server side for the dynamic creation of the viewer objects;

18. The computer software framework according to claim 1 further comprises a plurality of service providers each representing the integrations in a content management system at the server side for a unique viewer provider;

19. The computer software framework according to claim 18 wherein said service provider implements a standard programmable interface at the server side;

20. The computer software framework according to claim 18 wherein said service provider further comprises default implementations for said standard programmable interface at the server side, that can be shared by all viewer providers and overridden by the implementations for a specific viewer provider;

21. The service provider according to claim 20 comprises one or more of the following:
Function for reading artifacts from a viewer bundle;
Function for selecting a viewer provider among multiple viewer providers to handle a given document at runtime;
Function for providing runtime context for the rendering of viewer controls;
Function for retrieving document contents and annotation contents from the content management repository and delivering the retrieved contents to the requesting client;
Function for converting annotation contents from the format native to a specific viewer provider to a storage format which is neutral to all viewers and transparent to other components of the content management system;
Function for converting annotation contents from the storage format to the format native to a specific viewer provider;

22. The service provider according to claim 21 further comprises functions for rendering viewer controls;

23. The computer software framework according to claim 1 further comprises a plurality of service entry points at the server side that interfaces remote requests from the client side, and optionally delegates the client requests to said service providers at the server side;

24. The computer software framework according to claim 23 wherein said service entry points comprise functions for invoking implementations of said standard programmable interface at the server side;

25. The computer software framework according to claim 1 further comprises functions for adding new service entry points without modifying existing implementations for the software framework;

26. The computer software framework according to claim 1 wherein said single location for viewer bundle deployment includes but is not limited to a location on the server side where the content management system has access at runtime, or a location designated for the access from the design tools of the content management system at design time;

27. The computer software framework according to claim 26 wherein single location for viewer deployment comprises dropping a new viewer bundle that adds the viewer provider into the content management system, and removing a viewer bundle that removes the viewer provider from the content management system

28. The runtime context according to claim 13 comprises a set of data describing the status of the document and the associated annotations that a viewer control is to display at runtime, such data set provided by the content management system;

29. The design time context according to claim 13 comprises a set of data describing the status of the viewer control on a hosting client, such data set provided by a designer of the hosting client at design time;
